(19) United States
(12) Patent Application Publication
(10) Pub. No.: US 2023/0235129 A1
(43) Pub. Date: Jul. 27, 2023

(54) HYBRID POLYMER-MATRIX COMPOSITE AND PROCESSING METHOD

(71) Applicant: ARTECOLA QUÍMICA S.A., Campo Bom (BR)

(72) Inventors: Marcelo Lopes de ALBUQUERQUE, Itapetininga (BR); Eduardo Renato Kunst, Novo Manburgo (BR)

(21) Appl. No.: 18/008,922

(22) PCT Filed: Jun. 9, 2021
(86) PCT No.: PCT/BR2021/050252

§ 371 Date: Dec. 7, 2022

(30) Foreign Application Priority Data
Jun. 10, 2020 (BR) 102020011635-5

(51) Int. Cl. C08J 3/00; C08J 3/20; C08K 7/14; C08K 7/06

(52) U.S. Cl. CPC C08J 3/005; C08J 3/201; C08K 7/14; C08K 7/06; C08J 2323/06; C08J 2323/12; C08J 2323/08; C08J 2367/00; C08J 2375/04; C08J 2401/02; C08J 2497/02

(57) ABSTRACT

A hybrid polymer-matrix composite is described, containing between 10.0% and 45.0% by weight of cellulosic fiber up to 3.0 mm long and with a maximum moisture content of 5.0%; between 5.0% and 40.0% by weight of synthetic fiber up to 4.0 mm long and compatibilizing additives, said constituents being homogenized directly in the twin-screw extruder, with each reinforcing fiber entering via a specific feeder, to be adjusted to the temperature and shearing applied to the reinforcing fibers, guaranteeing the correct dispersion of the fiber for encapsulation by the polymer matrix, optimizing interface interactions and perfect homogenization.

### FIELD OF THE INVENTION

This invention patent describes a hybrid polymer-matrix composite and the respective method of processing the constituents of the hybrid polymer-matrix composite, in which the processing and homogenization of the constituents—cellulosic fiber, synthetic fiber, polymer and additives—is carried out directly in the twin-screw extruder, where each reinforcement fiber enters through a specific feeder, in order to adjust the temperature and the shear to which the reinforcement fibers are subjected, guaranteeing adequate dispersion of the fiber for encapsulation by the polymer matrix, optimizing the interfacial interactions and the perfect homogenization of the formulation components.

### BACKGROUND OF INVENTION

The ASTM D3878 (2007) standard defines composite materials as those formed by the combination of two or more materials, insoluble with each other, in which the combination of these materials forms a useful material with properties different from those found in isolated components.

Composites have two or more constituents that are physically distinct on a microscopic scale, separated by an interface. The matrix is the continuous constituent. The second constituent dispersed in the matrix is cited as a reinforcement phase that acts, in general, improving the mechanical properties of the matrix (MATTHEWS, F L; RAWLINGS, R D Composite materials: engineering and science. Londres: Chapman & Hall, 470 p.).

The quality of the interface between the matrix and the reinforcement is a factor of great importance in the mechanical performance of the composite, since the interface is responsible for transferring the load between the matrix and the reinforcement. For interaction to occur between components of different chemical natures and of any size or shape, the existence of a common contact area between them is essential (MANO, E B Polymers as engineering materials. 1 ed. São Paulo: Edgard Blucher, 2000. 197 p.).

With the imminent concern to reduce environmental impacts, but without losing the gains in desired properties, vegetable fibers are being commonly used as reinforcements in composites. In Brazil, there is a wide variety of plant fibers with different chemical, physical and mechanical properties (Marinelli, A L, Monteiro, M R and Ambrósio, J D, 2008, “Desenvolvimento de composites poliméricos com fibras vegetais naturais da biodiversidade: uma contribuição para a sustentabilidade amazônica ” Polímero: Ciência e Tecnologia, vol. 18, no. 2, pp. 92-99.). Polymer composites reinforced by vegetable fibers are an area of great interest in the industry, arising from the 1990s, provided by the requirements arising from public authorities regarding the use and final disposal of synthetic fibers and resins derived from petroleum, followed mainly by the awareness of consumers about the finitude of the planet's natural resources (SILVA, R V Polyurethane resin composite derived from castor oil and vegetable fibers. São Carlos: UFSCar, 2003. 157 p. Thesis (Doctorate)—Federal University of São Carlos, São Carlos, Sao Paulo, 2003).

Plant fibers have properties that directly influence the assembly of the composite, such as the porosity and fibrosity of its structure and the lamellar matrix. The most visible advantages of fiber-based composites, when compared to other synthetic materials, are the ability to renew the raw material, biodegradability, low cost, less abrasiveness in machinery and less environmental impact (ALMEIDA JR, J. H. S.; ORNAGHI JR, H. L.; AMICO, S. C.; AMADO, F. D. R. Study of hybrid interlaminate curaua/glass composites. In: Materials and Design, v. 42, p. 111-117. Elsevier, 2012). In addition to high specific mechanical properties, low density, low energy consumption and production cost. (PANNIRSELVAM, P. V. et al. Project development for coconut fiber production with clean technology innovation and energy generation. Revista Analytica, São Paulo, n. 15, p. 56-61, March 2005):

However, applications of polymer matrix composites with vegetable fibers are limited by their low mechanical performance and high moisture absorption when compared to composites with synthetic fibers.

An alternative is to associate natural and synthetic fibers, in a process called hybridization. Conventionally, in hybrid polymer-matrix composites, vegetal fibers and glass fiber are associated, since the latter presents a favorable relation between cost and mechanical performance. In addition, it can act as a chemical barrier preventing the contact of natural fibers, naturally hydrophilic, with water.

Bledzik and Gassan, when studying a hybrid composite with fiberglass and natural fiber, found a decrease in moisture absorption and, consequently, the dependence of mechanical properties on humidity was also reduced (BLEDZKI, A K, GASSAN, J., “Composites reinforced with cellulose based fibers”, Progress in Polymer Science, v. 24, pp. 221-274, 1999).

Several other authors highlight improved mechanical properties, reduced moisture absorption and resistance to environmental aging (due to less degradation of synthetic fibers) of hybrid composites compared to composites with natural fibers only (MOE, M T, LIAO, K., “Durability of bamboo-glass fiber reinforced polymer matrix hybrid composites”, Composite Science and Technology, v. 63, pp. 375-387, 2003.), (SREEKALA, M S, “The mechanical performance of hybrid phenol-formalde-based composites reinforced with glass and oil palm fibers”, Composite Science and Technology, v. 62, pp. 239-253, 2002.), (SEENA, Y. A., “Comparison of the mechanical properties of phenol formaldehyde composites reinforced with banana fibers and glass fibers”, Composite Science and Technology, v. 62, pp. 18571868, 2002.).

Document CN105647011 describes a composite comprising between 45-70 parts of polypropylene resin, 10-20 parts of glass fiber, 5-15 parts of a natural fiber, 1-5 parts of flame retardant, 3-8 parts of an ultraviolet screening agent, 2-6 parts dilauryl thiodipropionate, 4-10 parts calcium fluoride, 5-12 parts talcum powder, and 1-4 parts pine leaf powder.

Document US2003134085 describes a laminated piece comprising a core, fiber layers arranged on both sides of the core and impregnated with a polyurethane resin and an outer layer of Class A surface quality on one of the fiber layers and, optionally, a decorative layer on the second fiber layer. Processing methods that can be used to produce the articles with the aforementioned reinforcing substances are the NafpurTec processes, LFI-/FipurTec or Interwet and lamination processes. The composite material is produced at molding temperatures of 60-140° C. The outer layers comprise a layer of fibers impregnated with polyurethane resin.

Document US2001018118 describes a laminated thermoplastic composite comprising: a recycled thermoplastic matrix comprising at least one from the group consisting of polyethylene, polypropylene, nylon, PET and styrene-butadiene rubber; and a plurality of high modulus fibers, said high modulus fibers comprising at least one of the group consisting of glass fibers, natural fibers, carbon fibers and aramid fibers, each of said high modulus fibers having a minimum length of approximately (½) of an inch and a minimum module of one million psi.

WO20131 document 03999 describes a molding composition formulation that includes polypropylene, fiberglass and a polypropylene substitute including recycled sheet molding transfer film (recycled SMC film). The polypropylene substitute is present from 1 to 35 percent by total weight and can also include natural cellulosic fibers or powders.

However, despite the state of the art describing hybrid polymer-matrix composites with natural and synthetic fibers, conventionally the constituents are homogenized in the polymer, and then processed in conventional extrusion equipment. However, in view of the distinct characteristics of natural and synthetic fibrous reinforcements, the homogenization of the composite constituents requires specific conditions for each element in order to increase the reinforcement conditions achieved.

In the case of extrusion, the mixing conditions necessary to ensure good incorporation of the fibers into the polymer matrix require feeding the fiber in an advanced stage of the extruder, with the polymer duly melted, as well as sufficient dispersive and distributive mixing work to promote threshing of the strands of the fibers into individual filaments, wetting of their surface by the polymer to ensure good interfacial adhesion, and homogeneous dispersion of the fiber in the matrix, without, however, leading to excessive breakage in fiber length (Sekiya, T.; Nakamura, N.; Sugiyama M.; Hamada H.; Hamamoto A. & Hiragushi M.—“Study on Interfacial and Mechanical Properties in Glass Fiber Reinforced Polypropylene Injection Moldings”, in: “Design and structuring of Composites”, Proc. Joint Canada-Japan. Workshop on Composites, Kyoto, p. 265-268, August (1996)), (Ramani, K.; Bank, D. & Kraemer, N.—Polym. Composites, 16 (3), p. 258-66 (1995).), (Andersen, P. G.—“Mixing Practice in Corotating Twin Screw Extruders”, in: “Mixing and Compounding of Polymers: Theory and Practice”, I. Manas-Zloczower & Z. Tadmor (Eds.), Hanser, N.Y., p. 679-705 (1994).).

Thus, the object of this invention patent is a hybrid polymer-matrix composite reinforced with natural fibers and synthetic fibers, in a specific concentration and size, suitable for processing the composite in a double-screw extruder, where each component enters through a specific feeder, in order to adjust the temperature and shear to which the reinforcing fibers are subjected, ensuring adequate fiber dispersion for encapsulation by the polymer-matrix, optimizing interfacial interactions and perfect homogenization of the formulation components.

### SUMMARY

The invention describes a method of processing a hybrid polymer matrix composite that associates synthetic and vegetable fibers through an extrusion process, providing a product that reaches mechanical performance values superior to composites with mineral fibers associated with sustainability characteristics (material 100% recyclable), of lower weight when compared to polymer composites with glass fiber in their composition and with a reduction in odor and the emission of organic compounds (VOC) when compared to polymer composites with vegetable fibers.

The invention describes a hybrid composite of high performance polymer matrix and, at the same time, recyclable, providing the obtention of extruded products for application in multiple segments (ex. parts for vehicle interiors, thermoformable parts for furniture, reinforcements for shoes, compounds for injection and applications in other markets where mechanical and thermal resistance are essential, etc.).

### DETAILED DESCRIPTION OF THE INVENTION

The hybrid polymer-matrix composite, object of the present invention patent, comprises a polymer matrix in which is associated between 10.0 to 45.0% w/w of cellulosic fiber, between 5.0 to 40.0% w/w of synthetic fiber and compatibilizing additives to promote the interface between the reinforcing fibers (synthetic and natural) and the polymer matrix, in order to enhance the performance properties of the product, optimizing the performance of the final product, without losing the recycling property.

The polymer matrix is selected from polyethylene (PE), polypropylene (PP), ethyl vinyl acetate (EVA), polyester (PES) or thermoplastic polyurethane (TPU).

The cellulosic fiber has a fiber length of up to 3 mm and a maximum moisture content of 5%, and is preferably selected from wood, cane, coconut, jute and bamboo fibers.

The synthetic fibers are selected from glass fiber, carbon fiber or aramid fiber, with a length of up to 4 mm, adding considerably greater thermal and mechanical resistance to the product where it will be applied, as this type of fiber is more rigid and structured than the natural fiber.

The length of the incorporated fibers allows the possibility of dosing in the extruder feeders, without causing agglomeration.

The method of processing the hybrid polymer-matrix composite comprises the incorporation of the cellulosic fiber and the incorporation of the synthetic fiber in a specific feeder of a double-screw extruder. Thus, unlike state-of-the-art composites in which the reinforcing fillers are mixed with the polymer matrix prior to extrusion, in the method described in the present invention, the reinforcing fibers are added to the feeders in a specific concentration and size, due to the geometry of the transport screw, ensuring proper dispersion of the fiber for encapsulation by the polymer matrix and shear adjustment, in order to optimize interfacial interactions, with the shear adjustment being performed at the time of extrusion and not at the time of fiber dosing.

Mechanical and thermal tests were carried out with extruded parts using composite A (45.0% w/w of cellulosic fiber), composite B (40.0% w/w of cellulosic fiber and 10.0% w/w of synthetic fiber), composite C (30.0% w/w of cellulosic fiber and 20.0% w/w of synthetic fiber) and composite D (20.0% w/w of cellulosic fiber and 30.0% w/w of synthetic fiber), with the results shown in Table 1.

TABLE 1
mechanical and thermal tests

| Test | Composite A | Composite B | Composite C | Composite D |
|---|---|---|---|---|
| Density (g/cm³) | 1.06 to 1.10 | 1.10 to 1.14 | 1.14 to 1.18 | 1.18 to 1.22 |
| HDT L (° C.) | >110 | >125 | >135 | >140 |
| HDTT (° C.) | >90 | >105 | >115 | >120 |
| Vicat (° C.) | >115 | >125 | >130 | >135 |
| Modulus of elasticity under bending L (Mpa) | >3200 | >3500 | >4500 | >6500 |
| Modulus of elasticity under bending T (Mpa) | >2000 | >2200 | >2800 | >3000 |
| Flexural strength L (MPa) | >45 | >65 | >80 | >120 |
| Flexural strength T (Mpa) | >35 | >45 | >55 | >60 |
| Tensile strength L (MPa) | >20 | >30 | >40 | >60 |
| Tensile strength L (Mpa) | >15 | >20 | >30 | >35 |

Molding tests were carried out with the extruded plates using composite C, in traditional molding equipment, having a good moldability, presenting a conformation result, format copying and dimensional stability quite satisfactory.

1. HYBRID POLYMER-MATRIX COMPOSITE characterized by comprising a polymer matrix in which it is associated between 10.0 to 45.0% w/w of cellulosic fiber with up to 3.0 mm in length and maximum humidity of 5.0%; between 5.0 to 40.0% w/w of synthetic fiber up to 4.0 mm in length and compatibilizing additives.

2. HYBRID POLYMER-MATRIX COMPOSITE, according to claim 1, characterized in that the polymer matrix is selected from polyethylene (PE), polypropylene (PP), ethyl vinyl acetate (EVA), polyester (PES) or thermoplastic polyurethane (TPU).

3. HYBRID POLYMER-MATRIX COMPOSITE, according to claim 1, characterized in that the cellulosic fiber is selected from wood, cane, coconut, jute and bamboo fibers.

4. A hybrid polymer-matrix COMPOSITE characterized by the fact that cellulosic fiber and synthetic fiber are mixed with the polymer matrix during the extrusion process.
